(19) United States
(12) Patent Application Publication
(10) Pub. No.: US 2025/0176527 A1
(43) Pub. Date: Jun. 5, 2025

(54) Trash Can Bait Station Device

(71) Applicant: Kelvin White, Linden, NJ (US)

(72) Inventor: Kelvin White, Linden, NJ (US)

(21) Appl. No.: 18/918,349

(22) Filed: Oct. 17, 2024

Related U.S. Application Data
(60) Provisional application No. 63/606,186, filed on Dec. 5, 2023.

(51) Int. Cl. A01M 23/02; A01M 23/00; A01M 23/24; A01M 23/38; A01M 25/00; B65F 1/14

(52) U.S. Cl. CPC A01M 23/02; A01M 23/005; A01M 23/24; A01M 23/38; A01M 25/004; B65F 1/1473

(57) ABSTRACT

A trash can bait station device is provided designed to discreetly trap rodents or pests while maintaining the appearance and functionality of a standard garbage receptacle. The device comprises a body shaped like a typical garbage can, with features such as a lid, wheels, and handles. The body includes an opening at the bottom that houses a removable trap station, which is equipped with an entrance for rodents, a bait area, and a trap. The trap station may also have a transparent viewing window to allow users to monitor its contents without removing it from the trash can, thereby preventing detection by unauthorized individuals. The device employs different locking mechanisms to secure both the lid and the trap station, enhancing safety by restricting access to children.

### CROSS-REFERENCE TO RELATED APPLICATION

The present application claims priority to, and the benefit of, U.S. Provisional Application No. 63/606,186, which was filed on Dec. 5, 2023, and is incorporated herein by reference in its entirety.

### FIELD OF THE INVENTION

The present invention relates generally to the field of trash cans. More specifically, the present invention relates to a trash can bait station device comprised of a trash can body with a hidden, concealed, removable bait station that houses rodent traps and bait. Accordingly, the present disclosure makes specific reference thereto. Nonetheless, it is to be appreciated that aspects of the present invention are also equally applicable to other like applications, devices, and methods of manufacture.

### BACKGROUND

Mice and rat infestations are a frequent problem, especially in areas with multiple trash receptacles or where food waste is not properly managed. These rodents are attracted to food scraps and garbage, leading them to invade various environments such as schools, homes, hospitals, restaurants, and other public or private facilities. The presence of these pests not only creates unsanitary conditions but also poses health risks, as rodents can carry diseases that may spread to humans. Managing these infestations can be particularly challenging; for instance, setting individual mouse traps can be both frustrating and time-consuming. In addition to the inconvenience, there are significant safety concerns, especially in settings like schools where children could accidentally come across these traps, potentially leading to injuries or even psychological distress. This situation underscores the need for more effective and safer pest control methods that can address the issue without posing additional risks to people, particularly in sensitive environments.

Therefore, there exists a long-felt need in the art for an improved rodent trapping system. There also exists a long-felt need in the art for a trash can bait station device. More specifically, there exists a long-felt need in the art for a trash can bait station device that can be used to trap and kill rodents. Further, there exists a long-felt need in the art for a trash can bait station device that can be used to trap and kill rodents and wherein the system discretely conceals the trapping area from curious individuals such as but not limited to children.

The subject matter disclosed and claimed herein, in one embodiment thereof, comprises a trash can bait station device. The device is designed to discreetly trap rodents or pests while maintaining the appearance and functionality of a standard garbage receptacle. The device comprises a body shaped like a typical garbage can, with features such as a lid, wheels, and handles. The body includes an opening at the bottom that houses a removable trap station, which is equipped with an entrance for rodents, a bait area, and a trap. The trap station may also have a transparent viewing window to allow users to monitor its contents without removing it from the trash can, thereby preventing detection by unauthorized individuals. The device employs different locking mechanisms to secure both the lid and the trap station, enhancing safety by restricting access to children. Methods of using the device involve placing bait and traps inside the trap station, inserting it into the trash can, and securing it with locks, followed by periodic checks through the viewing window to determine if any rodents have been captured.

In this manner, the trash can bait station device of the present invention accomplishes all the forgoing objectives and provides an improved rodent trapping system. More specifically, the system accomplishes this by discretely concealing the trapping area from curious individuals such as but not limited to children. As a result, the system provides a safer alternative to rodent trapping in populated areas.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash can bait station device. The device is comprised of a body preferably shaped and configured in any style of garbage can/garbage receptacle body. The body may have common trash can features such as but not limited to a lid, a wheel, etc. The body is further comprised of at least one opening preferably positioned at a bottom area of the body and that receives at least one removable trap station.

The body of the trap station is comprised of at least one opening that allows a rodent to enter into the interior space of the body. The interior space may then be comprised of at least one bait and/or at least one trap. The bait may be any rodent and/or pest-attracting bait and the trap may be any type of rodent/pest trap.

In one embodiment, the body is comprised of at least one transparent viewing window preferably positioned on a top wall of the body such that any rodents trapped within the body can be viewed from the interior space of the trash can body via at least one transparent viewing window (and/or opening) within the trash can body. As a result, a user can discretely check the status of the trap station without having to remove the station from the trash can body, attracting unwanted attention to the presence of the trap station within the can body to surrounding individuals, such as but not limited to children. In one embodiment, the entire trap station is secured within the body via at least one locking mechanism that prevents unauthorized users such as children from removing the trap station.

The present invention is also comprised of a method of using the device. First, a device is provided comprised of a trash can body comprised of a body opening that receives at least one trap station, the trap station comprised of a body comprised of an opening, a viewing window, and an interior space. Then, a bait and/or a trap can be placed within the interior space via opening the viewing window. Next, the trap station can be placed into the opening of the body such that the trap station is concealed within the trash can body with the exception of the opening of the trap station. Finally, a user can check the contents of the trap station (i.e., for trapped rodents) via viewing the interior space through the viewing window and through a secondary viewing window within the interior space of the trash can body.

Accordingly, the trash can bait station device of the present invention is particularly advantageous as it provides an improved rodent trapping system. More specifically, the system discretely conceals the trapping area from curious individuals such as but not limited to children. In this manner, the trash can bait station device overcomes the limitations of existing methods and devices used to trap and kill rodents in populated areas known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trash can bait station device of the present invention in accordance with the disclosed architecture;

FIG. 2 illustrates a perspective view of a trap station one potential embodiment of a trash can bait station device of the present invention wherein the viewing window is open in accordance with the disclosed architecture;

FIG. 3 illustrates a perspective view of one potential embodiment of an interior space of a trash can body of a trash can bait station device of the present invention wherein the trap station is within the body in accordance with the disclosed architecture;

FIG. 4 illustrates a flowchart of a method of using one potential embodiment of a trash can bait station device of the present invention in accordance with the disclosed architecture; and

FIG. 5 illustrates a flowchart of a method of using one potential embodiment of a trash can bait station device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved rodent trapping system. There also exists a long-felt need in the art for a trash can bait station device. More specifically, there exists a long-felt need in the art for a trash can bait station device that can be used to trap and kill rodents. Further, there exists a long-felt need in the art for a trash can bait station device that can be used to trap and kill rodents and wherein the system discretely conceals the trapping area from curious individuals such as but not limited to children.

The present invention, in one exemplary embodiment, is comprised of a trash can bait station device comprised of a body preferably shaped and configured in any style of garbage can/garbage receptacle body. The body may have common trash can features such as but not limited to a lid, a wheel, etc. The body is further comprised of at least one opening preferably positioned at a bottom area of the body and that receives at least one removable trap station.

The body of the trap station is comprised of at least one opening that allows a rodent to enter into the interior space of the body. The interior space may then be comprised of at least one bait and/or at least one trap, wherein the bait may be any rodent and/or pest-attracting bait and the trap may be any type of rodent/pest trap.

In one embodiment, the body is comprised of at least one transparent viewing window preferably positioned on a top wall of the body such that any rodents trapped within the body can be viewed from the interior space of the trash can body via at least one transparent viewing window (and/or opening) within the trash can body. As a result, a user can discretely check the status of the trap station without having to remove the station from the trash can body, attracting unwanted attention to the presence of the trap station within the can body to surrounding individuals, such as but not limited to children. In one embodiment, the entire trap station is secured within the body via at least one locking mechanism that prevents unauthorized users such as children from removing the trap station.

The present invention is also comprised of a method of using the device. First, a device is provided comprised of a trash can body comprised of a body opening that receives at least one trap station, the trap station comprised of a body comprised of an opening, a viewing window, and an interior space. Then, a bait and/or a trap can be placed within the interior space via opening the viewing window. Next, the trap station can be placed into the opening of the body such that the trap station is concealed within the trash can body with the exception of the opening of the trap station. Finally, a user can check the contents of the trap station (i.e., for trapped rodents) via viewing the interior space through the viewing window and through a secondary viewing window within the interior space of the trash can body.

Accordingly, the trash can bait station device of the present invention is particularly advantageous as it provides an improved rodent trapping system. More specifically, the system discretely conceals the trapping area from curious individuals such as but not limited to children. In this manner, the trash can bait station device overcomes the limitations of existing methods and devices used to trap and kill rodents in populated areas known in the art.

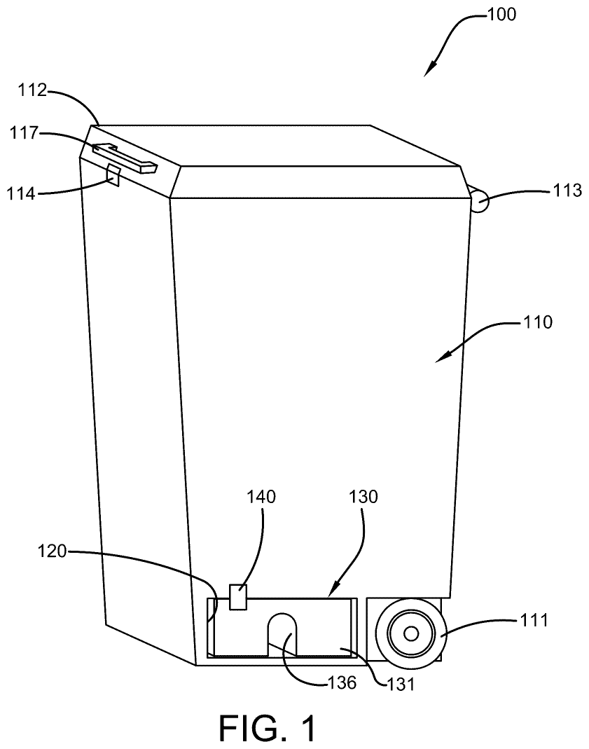

Referring initially to the drawings, FIG. 1 illustrates a perspective view of one potential embodiment of a trash can bait station device 100 of the present invention in accordance with the disclosed architecture. The device 100 is comprised of a body 110. The body 110 is preferably shaped and configured in any style of garbage can/garbage receptacle body 110. More example, the body 110 may be comprised of at least one lid 112 of any style. In one embodiment, the lid 112 is attached to the body 110 via at least one hinge 113 of any type. In one embodiment, the lid 112 may be secured to the body 110 via at least one locking mechanism 114 such as but not limited to a clip lock, a magnetic lock, etc. The body 110 may also be comprised of at least one wheel 111 of any type and configuration. In one embodiment, the body 110 is comprised of at least one handle 117 (of any style and configuration) positioned on the body 110 and/or lid 112.

The body 110 is further comprised of at least one opening 120. The opening 120 is preferably positioned at a bottom area of the body 110 and receives at least one removable trap station 130. The trap station 130 may be any shape but is preferably generally rectangular or square in shape. The body 131 of the trap station 130 is comprised of at least one opening 136 that allows a rodent to enter into the interior space 133 of the body 131. The interior space 133 may then be comprised of at least one bait 135 and/or at least one trap 134. The bait 135 may be any rodent and/or pest-attracting bait such as but not limited to an anticoagulant bait, a non-anticoagulant bait, a soft bait, a pellet bait, a block bait, a liquid bait, a gummy bait, a grain bait, a paste bait, etc. to attract a rodent into the trap station 130. The trap 134 may be any type of rodent/pest trap such as but not limited to a snap trap, a glue trap, an electronic trap, a live-capture trap, a multiple-catch trap, a bucket trap, an electric-shock trap, a tunnel trap, etc. The bait 135 may be positioned on/in the trap 134 in some embodiments or may be separate from the trap 134 in other embodiments.

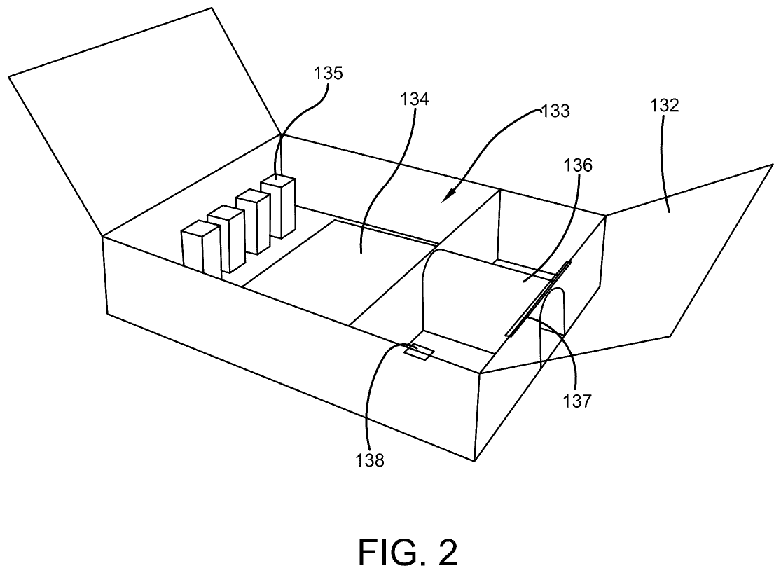

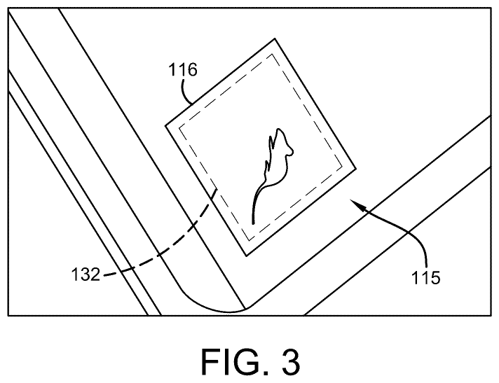

In one embodiment, the body 131 is comprised of at least one transparent viewing window 132. More specifically, the window 132 is preferably positioned on a top wall of the body 131 such that any rodents trapped within the body 131 can be viewed from the interior space 115 of the trash can body 110 via at least one transparent viewing window 116 (and/or opening) within the trash can body 110, as seen in FIG. 3. As a result, a user can discretely check the status of the trap station 130 without having to remove the station 130 from the trash can body 110, attracting unwanted attention to the presence of the trap station 130 within the can body 110 to surrounding individuals, such as but not limited to children. In one embodiment, the viewing window 132 attaches to the body 131 via at least one hinge 137 that allows the window 132 to be opened once the trap station 130 is removed from the trash can body 110 in order to gain access to the interior space 133, as seen in FIG. 2. The window 132 may be secured to the body 131 via at least one locking mechanism 138 such as but not limited to a clip, a clamp, a magnet, a lock, a childproof lock, etc. In one embodiment, the entire trap station 130 is secured within the body 110 via at least one locking mechanism 140 such as but not limited to a key lock, a combination lock, a childproof lock, etc. that prevents unauthorized users such as children from removing the trap station 130.

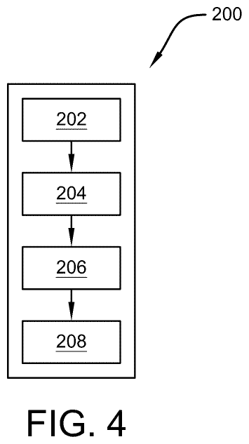

The present invention is also comprised of a method of using 200 the device 100, as seen in FIG. 4. First, a device 100 is provided comprised of a trash can body 110 comprised of a body opening 120 that receives at least one trap station 130, the trap station 130 comprised of a body 131 comprised of an opening 136, a viewing window 132, and an interior space 133 [Step 202]. Then, a bait 135 and/or a trap 134 can be placed within the interior space 133 via opening the viewing window 132 [Step 204]. The bait 135 may be placed on or in the trap 134 in one embodiment. Next, the trap station 130 can be placed into the opening 120 of the body 110 such that the trap station 130 is concealed within the trash can body 110 with the exception of the opening 136 of the trap station 130 [Step 206]. Finally, a user can check the contents of the trap station 130 (i.e., for trapped rodents) via viewing the interior space 133 through the viewing window 132 and through a secondary viewing window 116 within the interior space 115 of the trash can body 110 [Step 208].

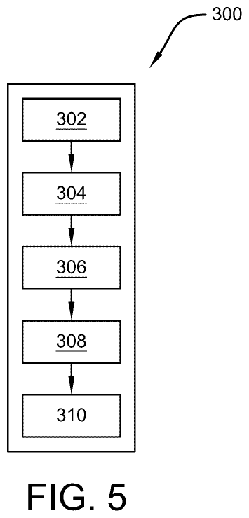

The present invention is also comprised of a method of using 300 the device 100, as seen in FIG. 5. First, a device 100 is provided comprised of a trash can body 110 comprised of a body opening 120 that receives at least one trap station 130, the trap station 130 comprised of a body 131 comprised of an opening 136, a viewing window 132, and an interior space 133 [Step 302]. Then, a bait 135 and/or a trap 134 can be placed within the interior space 133 via opening the viewing window 132 [Step 304]. The bait 135 may be placed on or in the trap 134 in one embodiment. Next, the trap station 130 can be placed into the opening 120 of the body 110 such that the trap station 130 is concealed within the trash can body 110 with the exception of the opening 136 of the trap station 130 [Step 306]. Then, the user can secure the trap station 130 within the body 110 via engaging a locking mechanism 140 to secure the trap station 130 to the body 110 [Step 308]. Finally, a user can check the contents of the trap station 130 (i.e., for trapped rodents) via viewing the interior space 133 through the viewing window 132 and through a secondary viewing window 116 within the interior space 115 of the trash can body 110 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trash can bait station device” and “device” are interchangeable and refer to the Trash can bait station device 100 of the present invention.

Notwithstanding the forgoing, the trash can bait station device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trash can bait station device 100 as shown in the FIGS. are for illustrative purposes only, and that many other sizes and shapes of the trash can bait station device 100 are well within the scope of the present disclosure. Although the dimensions of the trash can bait station device 100 are important design parameters for user convenience, the trash can bait station device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash can bait station device comprising:
a trash can body comprised of:
a lid;
a first interior space comprised of a first viewing window; and
a handle;
a first opening;
a trap station comprised of:
a trap station body comprised of a second viewing window, the viewing window attached to the trap station body via a hinge, a second interior space, and a second opening;
a bait; and
a trap.

2. The trash can bait station device of claim 1, wherein the lid attaches to the trash can body via a hinge.

3. The trash can bait station device of claim 1, wherein the handle is positioned on the lid.

4. The trash can bait station device of claim 1, wherein the first opening receives the trap station.

5. The trash can bait station device of claim 1, wherein the bait is comprised of an anticoagulant bait, a non-anticoagulant bait, a soft bait, a pellet bait, a block bait, a liquid bait, a gummy bait, a grain bait, or a paste bait.

6. The trash can bait station device of claim 1, wherein the trap is comprised of a snap trap, a glue trap, an electronic trap, a live-capture trap, a multiple-catch trap, a bucket trap, an electric-shock trap, or a tunnel trap.

7. The trash can bait station device of claim 1, wherein the bait is positioned on the trap.

8. A trash can bait station device comprising:
a trash can body comprised of:
a wheel;
a lid;
a first interior space comprised of a first viewing window; and
a handle;
a first locking mechanism;
a first opening;
a trap station comprised of:
a trap station body comprised of a second viewing window, the viewing window attached to the trap station body via a hinge, a second interior space, a second locking mechanism, and a second opening;
a bait; and
a trap.

9. The trash can bait station device of claim 8, wherein the handle is positioned on the trash can body.

10. The trash can bait station device of claim 8, wherein the first opening receives the trap station.

11. The trash can bait station device of claim 8, wherein the trap station is secured within the first opening via a third locking mechanism.

12. The trash can bait station device of claim 11, wherein the third locking mechanism is comprised of a key lock, a combination lock, or a childproof lock.

13. The trash can bait station device of claim 8, wherein the second locking mechanism is comprised of a clip, a clamp, a magnet, or a childproof lock.

14. The trash can bait station device of claim 8, wherein the bait is positioned within the trap station body.

15. The trash can bait station device of claim 8, wherein the trap is positioned within the trap station body.

16. The trash can bait station device of claim 8, wherein the first locking mechanism secures the lid to the trash can body.

17. A method of using a trash can bait station device, the method comprising the following steps:
providing a trash can bait station device comprised of a trash can body comprised of a body opening that receives at least one trap station, the trap station comprised of a trap station body comprised of a trap station opening, a viewing window, and an interior space;
placing a bait and a trap within the interior space;
placing the trap station into the body opening; and
checking a content of the trap station via viewing the interior space through the view window through a secondary viewing window within the trash can body.

18. The method of using a trash can bait station device of claim 17, wherein the trash can body is comprised of a lid and a first locking mechanism.

19. The method of using a trash can bait station device of claim 17 further comprised of a step of securing the trap station into the body opening via engaging a second locking mechanism.

20. The method of using a trash can bait station device of claim 17, wherein the trash can body is comprised of a wheel.
